(19) United States
(12) Patent Application Publication
(10) Pub. No.: US 2021/0226988 A1
(43) Pub. Date: Jul. 22, 2021

(54) TECHNIQUES FOR DISAGGREGATED DETECTION AND MITIGATION OF DISTRIBUTED DENIAL-OF-SERVICE ATTACKS

(71) Applicant: RADWARE, LTD., Tel Aviv (IL)

(72) Inventors: David AVIV, Tel Aviv (IL); Doron SHAVIT, Tel Aviv (IL); Benny ROCHWERGER, Tel Aviv (IL)

(73) Assignee: RADWARE, LTD., Tel Aviv (IL)

(21) Appl. No.: 17/138,029

(22) Filed: Dec. 30, 2020

Related U.S. Application Data
(60) Provisional application No. 62/955,615, filed on Dec. 31, 2019.

(51) Int. Cl. H04L 29/06

(52) U.S. Cl. CPC H04L 63/1458; H04L 63/20; H04L 63/1425; H04L 63/1416

(57) ABSTRACT

A system, and method therefor for disaggregated detection denial-of-service (DDoS) are provided. The system includes a plurality of detectors deployed on a plurality of network nodes, wherein each network node is connected to an edge network, wherein one detector of the plurality of detectors is deployed in each of the plurality of network nodes, wherein each of the plurality of detectors is configured to detect and characterize at least a DDoS attack by analyzing telemetries received by the respective network node in which the detector is deployed.

### CROSS-REFERENCE TO RELATED APPLICATIONS

This application claims the benefit of U.S. Provisional Application No. 62/955,615 filed on Dec. 31, 2019 the contents of which are hereby incorporated by reference.

### TECHNICAL FIELD

The present disclosure relates generally to security solutions for edge-networks and, more specifically, to protection against DDoS attacks.

### BACKGROUND

The 5G standard is the fifth generation technology standard for broadband cellular networks. As 5G standard grows in popularity, the technology is expected to bring new use cases and business models for consumers, businesses, and the telecommunication industry as a whole. In addition, the 5G standard will lay the foundation for massive adoption of Internet of Things (IoT) devices everywhere, including environmental sensors, gaming, telemedicine, manufacturing, agriculture, autonomous cars, and so on.

To support the expected diversity of new applications over a 5G network, communication service providers (CSPs) or Internet service providers (ISPs) adapt technologies and methodologies initially developed for data centers and cloud computing platforms. Such technologies include network function virtualization (NFV), software defined networks (SDN), and virtual entities (such as software containers and micro-services). By adopting such technologies, CSPs and ISPs can provide the scale and performance required by applications carried over the 5G network (hereinafter “5G applications”).

Further, the 5G network and supporting infrastructure are required to provide low latency and high bandwidth in order to support 5G applications. To this aim, 5G networks are designed to be integrated with multi-access (mobile) edge computing (MEC). The MEC architecture creates a critical bridge between 5G networks and cloud computing infrastructure. By deploying computing and storage resources close to the Radio Access Network (RAN), CSPs and ISPs can optimize the delivery of latency-sensitive content and services to their end users.

The new infrastructure emerging from adopting the 5G standard introduces significant cyber threats, and, specifically, distributed denial of service (DDoS) threats against the network infrastructure. For example, connectivity of millions of IoT devices deployed everywhere may be exploited to execute a DDoS attack. As such devices are generally distributed, the traditional model for perimeter-based or appliance-based cyber protection is impractical for detecting and mitigating such threats.

FIG. 1 is a schematic diagram 100 of a traditional security model for detecting DDoS attacks. Here, traffic directed to a protected entity (e.g., a server or data center) is inspected. First, at S110, during a learning phase, one or more baselines demonstrating normal behavior of the traffic are learned. The baselines can be computed for traffic features demonstrating normal behavior. For example, such features may include rate-based features (e.g., packets per second) and/or rate-invariant features (e.g., packet size).

Once baselines are established, at S120, during an operation phase, abnormal behavior is detected based on the incoming traffic and the computed baselines. For example, a threshold for a packets per second feature is computed based on the respective threshold. The packets per second of incoming traffic is compared to the computed threshold to determine abnormal behavior. Based on a detected anomaly, at S130, the anomaly (hence, a potential cyber-attack) is characterized to create a policy to mitigate any malicious traffic. The mitigation action, performed at the mitigation phase S140, may include cleaning valid traffic from malicious traffic, blocking traffic from reaching a protected entity 101, rate limiting the traffic, and so on.

The traditional security model discussed herein is typically implemented by a security system deployed in-line of traffic between a network and protected entities. That is, all traffic should be directed through such a system for inspection. Such a deployment may be efficient for resources of a centralized data center, but not for distributed and disaggregated network infrastructures.

It would, therefore, be advantageous to provide a cybersecurity solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a system for disaggregated detection denial-of-service (DDoS) attacks. The system comprises a plurality of detectors deployed on a plurality of network nodes, wherein each network node is connected to an edge network, wherein one detector of the plurality of detectors is deployed in each of the plurality of network nodes, wherein each of the plurality of detectors is configured to detect and characterize at least a DDoS attack by analyzing telemetries received by the respective network node in which the detector is deployed.

Certain embodiments disclosed herein include a method a method for disaggregated detection denial-of-service (DDoS) attacks. The method comprises deploying a plurality of detectors on a plurality of network nodes, wherein each network node is connected to an edge network; and instantiating a plurality of security functions on each of the plurality of detectors, wherein the plurality of security functions; activating a first security function to detect anomalies in the telemetries received by the respective network node, wherein the detected anomalies are indicative of a potential DDoS attack; activating a second security function to generate attack signatures based on the detected anomalies; and activating a third security function to generate at least one mitigation policy based on the generated attack signatures.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram explaining a traditional security model for detecting DDoS threats or attacks.

FIG. 2 is an example diagram of a distributed and disaggregated network utilized to describe the various embodiments.

FIG. 3 is a schematic diagram demonstrating the distributed and disaggregated model according to an embodiment.

FIG. 4 is a diagram depicting data flow in a cloud-based solution for a cellular network according to an embodiment

FIG. 5 is a diagram depicting a microservices-based cloud infrastructure according to an embodiment.

FIG. 6 is an example diagram illustrating a process for on-demand traffic inspection according to an embodiment.

FIG. 7 is a schematic diagram of a hardware layer of a node according to an embodiment.

FIG. 8 is an example flowchart of a method for disaggregated detection denial-of-service (DDoS) attacks according to an embodiment.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a method for [PURPOSE]. The method comprises [STEPS]

Certain embodiments disclosed herein also include a non-transitory computer readable medium having stored thereon instructions for causing a processing circuitry to execute a process for [PURPOSE], the process comprising [STEPS].

In addition, certain embodiments disclosed herein include a system for [PURPOSE]. The system comprises: a processing circuitry; and a memory, the memory containing instructions that, when executed by the processing circuitry, configure the system to: [STEPS].

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for providing cyber security protection for distributed and disaggregated networks. Specifically, the disclosed embodiments include a decentralized security system based on multiple security functional components (hereinafter security functions) deployed at different points in the network. Insights generated by such security functions can be combined to provide overall protection for the network. A security function can be implemented as a virtual entity including a microservice, a software container, any other type of virtual entity, and the like. In an embodiment, the security functions are configured to detect and mitigate cyber-attacks, such DoS/DDoS attacks, various type malware attack, and the like. The processing latency of the security function is minimal, allowing inspection of traffic at wire-speed.

The volume and rate of traffic in networks, such as 5G, are expected to grow exponentially. Implementing the distributed and disaggregated cyber-security model on such traffic volumes and rates, using existing solutions, may require extensive computing resources to inspect and analyze traffic at the higher layers (e.g., layers 3-4 to layer 7 of the OSI model). According to the disclosed embodiments, a novel method for allowing on-demand inspection of traffic is provided.

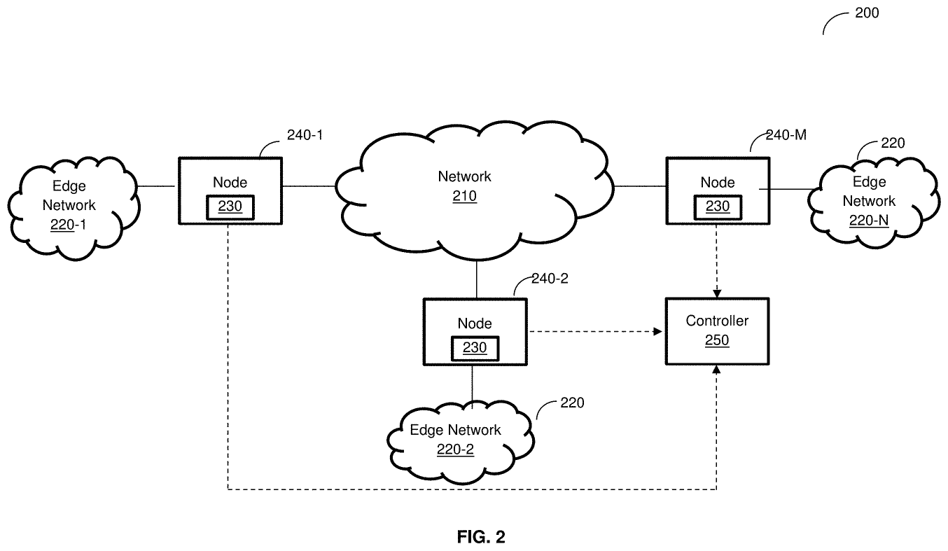

FIG. 2 is an example diagram of a distributed and disaggregated network 200 utilized to describe the various embodiments. A network 210 provides backbone connections to a plurality of edge networks 220-1 through 220-N (where N is an integer equal to or greater than 1). The backbone network 210 may be operated or maintained by an internet service provider (ISP) or other service provider, a network carrier, a cloud provider, enterprises, and the like. In an embodiment, the backbone network 210 is a 5G cellular network.

An edge network 220 may be a datacenter, an enterprise network, a private cloud, a public cloud, and the like. Each edge network 220 allows access to a plurality of computing resources, such as IoT devices, end-user devices (e.g., smartphones, wearable devices, tablet computers, etc.), servers (virtual or physical), edge computing nodes, and virtual entities (e.g., virtual machines, software containers, micro services, etc.) configured to execute applications, services, or both.

Any computing resource (not shown) connect to an edge network 220 can, potentially, communicate with other computing resources connected to the same or different edge networks 200. An example for such a compute resource may be, but is not limited to, a server, a computer, an IoT device, and storage device, or any device with a network connectivity. In most cases, traffic flows to and from such computing resources are not secured. As such, new cyber threats can be utilized to attack the infrastructure of the network 210 and the edge networks 220 as attacks are executed against computing resources connected to the network.

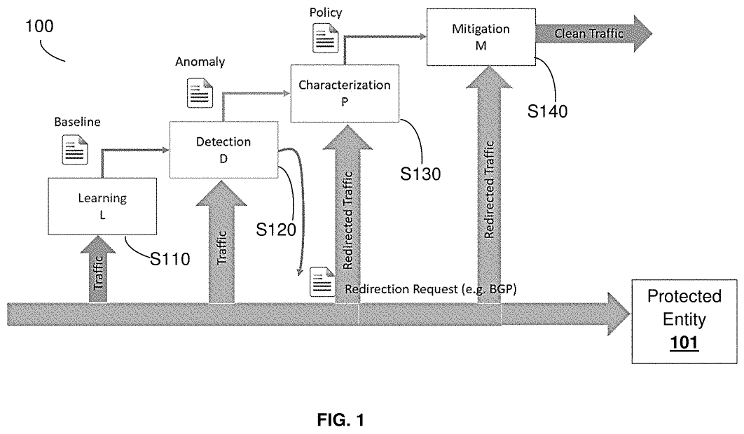

To defend the distributed and disaggregated network 200, detectors 230 (hereinafter detectors) are deployed in nodes 240-1 through 240-M (where M is an integer having a value of 1 or greater) on the edges of the backbone network 210, i.e., between each edge network 220 and the network 210. Although not specifically shown in FIG. 1, the detectors 230 can be deployed in any location of the network 210, of an edge network 220, or both. Each detector 230 is configured to execute one or more security functions for at least detecting cyber threats such as, but not limited to, DDoS threats.

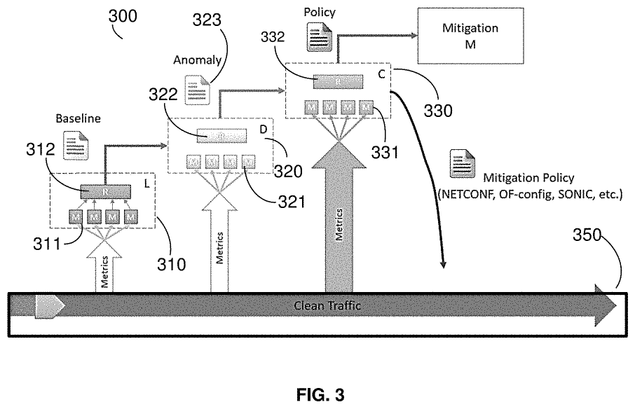

Each detector 230 is configured to inspect telemetries at essentially wire-speed, and, thus does not introduce additional latency to the network. The functions of each detector 230 implement a distributed and disaggregated security model discussed in more detail below with respect to FIG. 3

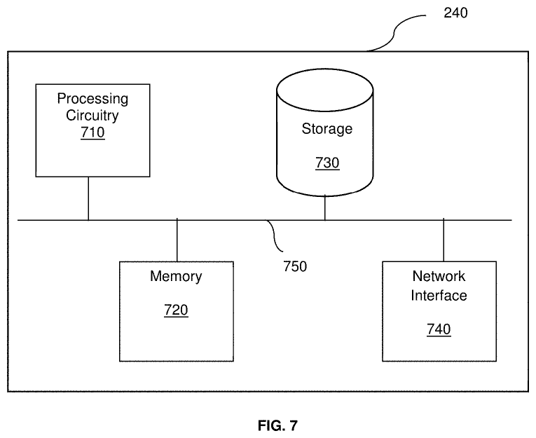

In an embodiment, each detector 230 is realized as a lightweight detector executed over a hardware layer of a node 240 including at least a memory and a processor (not shown in FIG. 2). The hardware layer may be provided by a network node such as, but not limited to, a switch, a hub, a router, a load balancer, an analog-to-digital (ADC) converter, and the like. In yet another configuration, the hardware layer may be provided by a compute node, e.g., a server. An example diagram of such a hardware layer is described further below with respect to FIG. 7. The lightweight detector may be realized as a software container, a microservice, a lightweight virtual machine, and the like.

In an embodiment, the detectors 230 and their security functions are executed independently. For example, one detector 230 can execute a function for anomalies detection, while another detector 230 may execute a separate function for characterizing the generated the attack signatures. In an embodiment, a detector 230 may be configured to implement mechanisms that enable enforcement of mitigation of attacks directly on the underlying network without the need for redirection of traffic.

In an embodiment, a controller 250 is configured to orchestrate the operation of the detectors 230. The controller 250 is configured to provision each of the detectors 230, receive statuses about the state of attack (detected, on-going, ended) as detected by each detector 230, and provide a status of an attack or attacks across all edge networks 220. In an embodiment, the controller 230 is configured to instruct each detector to execute a mitigation action (e.g., block malicious traffic, redirect malicious traffic, etc.). It should be noted that the controller 250 does not make attack detection decisions for the detectors 230.

In an embodiment provisioning a detector by the controller 250 includes instantiating a detector 230 on a network node, maintaining a state of each detector 230, setting various parameters of each detector 230, and so on. The parameters may include various thresholds for starting and stopping the operation of a detector, IP address to monitor, and the like.

The controller 250 is configured to receive alerts on detected attacks in real time and to report those alerts to a user (not shown). The received alerts may be saved in a database or other storage (not shown). In an embodiment, the controller 250 is configured to run a forensic process on the alerts saved in the database. The forensic process can determine the type of the attack, the impacted entities, and so on. The controller 250 may be realized as a virtual machine, a physical machine, or a combination thereof.

FIG. 3 is a schematic diagram 300 demonstrating the distributed and disaggregated cyber-security model as implemented by one of the detectors 230 according to an embodiment.

To implement this model, the detector 230 is configured to execute multiple instances of the same security function. A security function may include, but is not limited to, a baseline computation 310, an anomaly detection 320, and an attack characterization 330. Each such security function operates on a set of telemetries derived from the traffic, but a security function does not process the actual traffic. In an embodiment, the telemetries relate to layers 3-4 (TCP/IP) traffic attributes, and may include packets per second (from a specific IP address), flows per second, bytes per second, and the like. The telemetries are provided by the network node.

In an embodiment, multiple instances of each security function are executed, each of which processes a subset of the received metrics. Each instance of the security function may include a respective instance of the baseline computation 310, of the anomaly detection 320, and of the attack characterization 330. As shown in FIG. 3, different instances 311 of the baseline computation function 310 may each compute a baseline for a subset of the received metrics fed into the respective instances 311. A baseline, in an embodiment, can be computed by an instance 311 using an Infinite Impulse Response (IIR), fuzzy logic, machine learning techniques, or any other computation technique.

In an embodiment, an overall baseline of the entire set (not just a subset of the metrics) is determined using a MapReduce technique. One of ordinary skill in the art would appreciate that a MapReduce is a programming model for processing and generating large data sets with a parallel, distributed algorithm on a cluster. A MapReduce program is composed of a map procedure that filters and sorts data, and a reduce method which performs a summary operation. As a non-limiting example, the filtration and sorting of data may include sorting students by first name into queues, with one queue for each name. The reduce method would include counting the number of students in each queue, thereby yielding name frequencies.

To this end, in order to determine the overall baseline, the baseline computation function 310 also includes an aggregator instance 312 that aggregates the baselines computed by the instances 311.

In an embodiment, each instance 321 of the anomaly detection function 320 is configured to detect anomalies based on the subset of the received metrics fed into the respective instance 321 and the computed baseline. In an embodiment, each instance 312 may implement fuzzy logic to detect an anomaly. In another embodiment, anomalies can be detected using IIR or a machine learning technique. The aggregator instance 322 is configured to aggregate any anomalies determined by the respective instances 312 in order to determine if a cross-instance anomaly is detected. The aggregator instance 322 also implements a MapReduce method.

Each instance 331 of the attack characterization 330 is configured to generate an attack signature based on the set subset of the received metrics fed into the respective instance 331 and the determined cross-instance anomaly. The aggregator instance 332 is configured to aggregate any generated signatures into a single aggregated signature. The aggregator 332 is further configured to generate rules that would be utilized to mitigate the attack.

In an embodiment, the generated security rules are enforced on the programmable data plane 350. The aggregator instance 332 also implements a MapReduce method. The generated security rules may be part of a mitigation policy. In a further embodiment, the detected anomalies 322 and the generated mitigation policy can be reported to a global controller (e.g., the controller 250, FIG. 2). It should be noted that each instance can be realized as a software container, a microservice, a lightweight virtual machine, and the like.

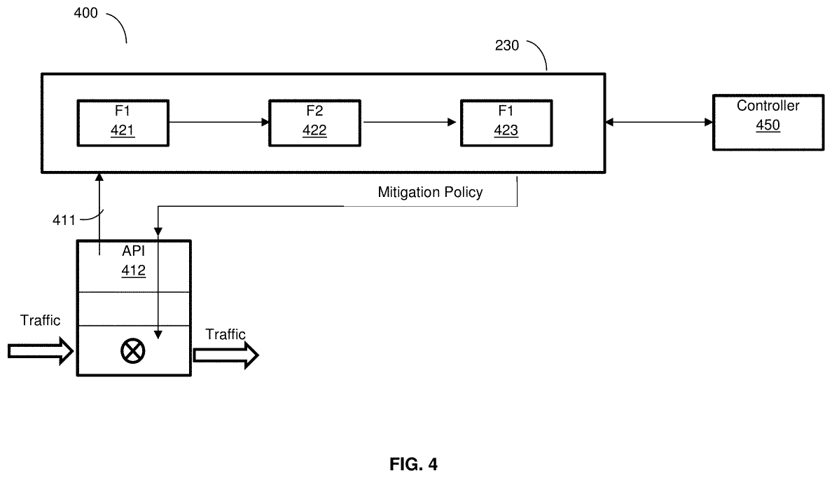

FIG. 4 is an example illustration 400 depicting generation and enforcement of security rules according to an embodiment. In the embodiment shown in FIG. 4, the rules are generated by the detector 230, FIG. 2.

As noted above, a detector 230 is a virtual entity executed in a network node (e.g., a switch). Thus, the detector 230 can sample or tap incoming traffic at essentially wire-speed. As illustrated in FIG. 1, telemetries 411 is collected or otherwise sampled through an application programming interface (API) 412 such as a NOS API. The metered data may include layer-1 traffic.

The telemetries 411 is analyzed by security functions implemented by the detector 230. Specifically, a first security function F1 (detection) 421 is an anomaly detection configured to detect anomalies in the traffic. In an embodiment, the analyzed traffic is layer-1 traffic. When an anomaly is detected, a second security function F2 (characterization) 422 is activated to characterize a detected attacked. The second security function F2 422 is configured to generate attack signatures, to identify the attacker (e.g., its Internet Protocol address), or both.

A third security function F3 (mitigation) 423 is then activated to generate a policy including a set of mitigation rules based on the attack characterization. An example for a mitigation rule may be clock traffic including an identified attack signature. The generated policy or policies are used to configure the network node, so that such policy can be enforced directly by its underlying hardware. In an embodiment, the generated policies are reported to the controller 250 (discussed in FIG. 2).

It should be noted that multiple instances of the same security function (421, 422, or 423) can be instantiated and activated on the same detector 230. The security functions can be instantiated and activated on-demand (e.g., under control of the controller) or when the detector 230 is required to process high volume of traffic.

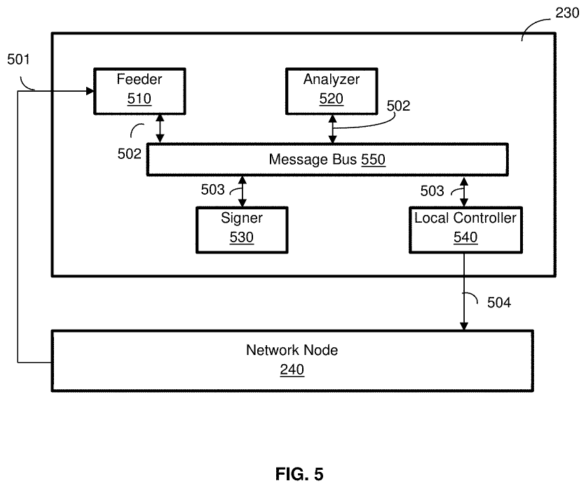

FIG. 5 is an example illustration depicting a functional block diagram of the detector 230 according to an embodiment. The detector 230 may be implemented as a software agent realized via a software container, a micro-service, a lightweight virtual machine, and the like. The detector 230, and hence the software agent, is executed over a hardware layer of a compute node or a network node, examples of which are provided above. It should be noted that software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry of a compute node or a network node, cause the processing circuitry to perform the various processes described herein. An example schematic diagram for the hardware layer which may be utilized for executing the detector (software agent) is shown in FIG. 7.

The logical components of the detector 230 include a feeder 510, an analyzer 520, a signer, 530, and a local controller 540, all connected to a message bus 550. FIG. 5 further illustrates the interfaces with the network node 240, such interfaces may be realized as an API.

The feeder 510 is configured to receive raw telemetries 501 from the data stream passing through a network node 240. In the embodiment shown in FIG. 5, a feeder 510 may be configured to receive raw telemetries from the message bus 550. The feeder 510 may be configured to return normalized data 502 back to the analyzer 520 via the message bus 550. In an alternative embodiment (not shown), the feeder 510 may be configured to output normalized data 502 directly to the analyzer 520. The data is normalized so that all messages will be presented in a unified format, data structure, or both. In an embodiment, the feeder 510 may be configured to receive information or telematics using protocols including, but not limited to, Tcpdump, Netflow5, Suricata, Netflow9, Sflow, gRPC, Google® Protocol Buffers, and the like. A detector 320 can implement logic or be configured with fuzzy logic, an infinite impulse response (IIR) filter, and the like.

In addition, the analyzer 520 may be configured to receive normalized data 502 from the message bus 550. In an alternative embodiment, the analyzer 520 may be configured to receive normalized data 502 directly from the feeder 510. The analyzer 520 is configured to process and analyze the normalized data 502 to determine whether any anomalies exist in the received normalized data 502. Anomalies are detected by comparing metrics of incoming traffic to one or more computed baselines. To this end, the analyzer 520 may implement techniques for anomaly detection, such as IIR, fuzzy logic, machine learning, and the like. In an embodiment, the analyzer 520 is configured to inspect and analyze telemetries at layers 3-4 of the OSI mode. The telemetries may include packets per second (from a specific IP address), flows per second, bytes per second, TCP flags, and the like. The telemetries are provided by the network node 240. The analyzer 520 can detect anomalies indicating on attack types including, but not limited to, flood, stress, HTTPS, OOS, DNS, and the like.

The analyzer 520 may then pass the list of detected anomalies to the message bus 550. In an alternate embodiment, the analyzer 520 may pass the list of detected anomalies directly to the signer 530.

The signer 530 is configured to receive a list of detected anomalies and to output a list of attack signatures 503. In the embodiment shown in FIG. 5, the signer 530 may be configured to receive the list of detected anomalies from the message bus 550 and to output the list of attack signatures 503 to the message bus 550 (as shown) and/or directly to the local controller 540 (not shown). The signer 530 may be configured to generate signatures for attack types including, but not limited to, flood, stress, HTTPS, OOS, DNS, and the like.

The local controller 540 is configured to receive a list of attack signatures 503 and to output one or more policies 504. Each such policy 504 includes a list of mitigation rules generated based on the attack signatures 503. In the embodiment shown in FIG. 5, the local controller 540 may be configured to receive the list of attack signatures 503 from the message bus 550 and/or directly from the signer 530.

The local controller 540 can configure the network node 240 with the policies 504. Thus, the mitigation rules may be applied at the network node 240 to inspect the traffic passing through the network node 240 and to, possibly, trigger a mitigation action including, but not limited to, blocking flagged traffic, quarantining flagged traffic, redirecting flagged traffic to a scrubbing center, other like operations, and any combination thereof. In an embodiment, the local controller 540 is configured to provide the generated polices 504 to the global controller (e.g., the controller 250, FIG. 2).

In an embodiment, the detector 230 is configured to alert the global controller (e.g., controller 250, FIG. 2) about the attack and its signature, the global controller is configured to approve the mitigation policy suggested by the signer 530. Once approved, the notifies the global controller is configured to notify the local controller 540 about the policy to enforce via the message bus 530.

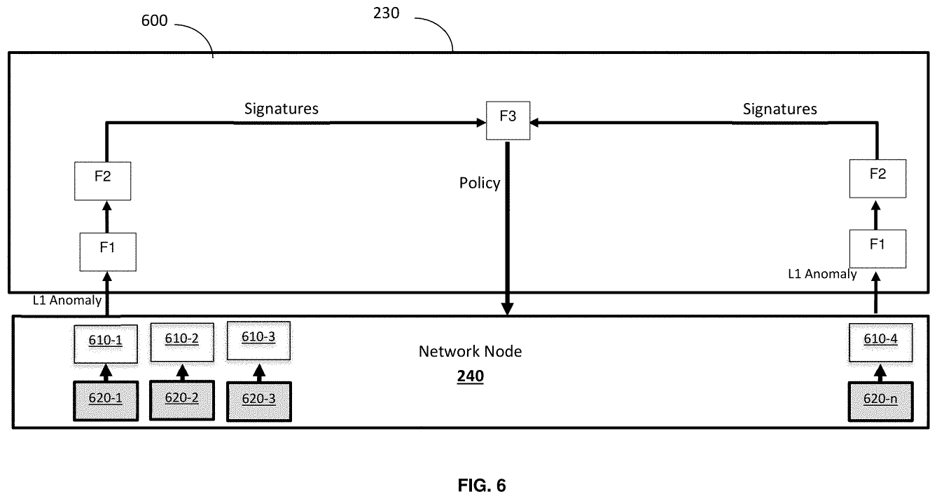

FIG. 6 is an example diagram 600 illustrating a process for on-demand traffic inspection according to an embodiment. As volume and rate of traffic in networks, such as 5G, are expected to grow exponentially, there is a need to implement the distributed and disaggregated cyber-security model on such traffic volumes and rates without extensive computing resources. The disclosed embodiments allow to inspect high volume of traffic using detectors (software agents) executed over existing compute or network nodes. That is, there is no need to install, deploy, or utilize high compute resources when implementing the disclosed embodiments.

In the embodiment shown in FIG. 6, a respective native detector 610 is implemented in each interface (port) 621 of a network node 240. The network node 240 is installed in the edge of a network (e.g., a 5G network), and can transfer traffic at very high rates (e.g., 400Gbps).

Each native detector 610 is configured to monitor Layer-1 (physical layer) traffic. The physical layer is responsible for the ultimate transmission of digital data bits from the physical layer of the sending (source) device, over network communications media, to the physical layer of the receiving (destination) device. At the physical layer, data is transmitted using the type of signaling supported by the physical medium such as, but not limited to, electric voltages, radio frequencies, or pulses of infrared or ordinary light.

In an embodiment, each native detector 610 is configured to count the bits per second sent or received through the respective port 620. When the counted rate (e.g., bits per second) diverts from a baseline, a Layer-1 (physical layer) anomaly is detected. The baseline considered by a native detector 610 is a layer-1 baseline (e.g., bits per second) which may be learned by the detector 610 or predetermined (e.g., preconfigured by a user).

In an embodiment, each native detector 610 can be implemented using a set of counters or registers and requires minimal computing resources (e.g., CPU time and memory) from the network node 240.

In an embodiment, when a Layer-1 anomaly is detected, the respective detector 610 triggers an anomaly alert to the detector 230. As noted above, the detector 230 is configured to receive real-time samples of the telemetry at layers 3-4 (TCP/IP) or layer 7 (application layer), and to process the sampled traffic using the security functions according to the distributed and disaggregated cyber-security model discussed above. The security functions include detection function “F1”, characterization function “F2”, and mitigation function “F3”. As depicted in FIG. 6, a mitigation policy, determined by the detector 230, is enforced on the network node 240.

It should be noted that anomaly alerts can be generated by multiple native detectors 610 simultaneously. The detector 230 may threat such alerts separately or in combination. It should be further noted that in the embodiment shown in FIG. 6, the detector 230 is activated only when a layer-1 anomaly is triggered.

FIG. 7 is an example block diagram of a hardware layer depicting a node 240, according to an embodiment. The node 240 may be a compute node or a network node and includes a processing circuitry 710 coupled to a memory 720, a storage 730, and a network interface 740. In an embodiment, the components of the security system 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or another memory technology, compact disk-read only memory (CD-ROM), Digital Versatile Disks (DVDs), or any other medium which can be used to store the desired information.

The network interface 740 allows the node 420 to communicate with the various components, devices, and systems described herein for production code static analysis, as well as other, like, purposes. The network interface 740 can be a port of the network node.

It should be understood that the embodiments described herein are not limited to the specific architecture illustrated in FIG. 7, and other architectures may be equally used without departing from the scope of the disclosed embodiments.

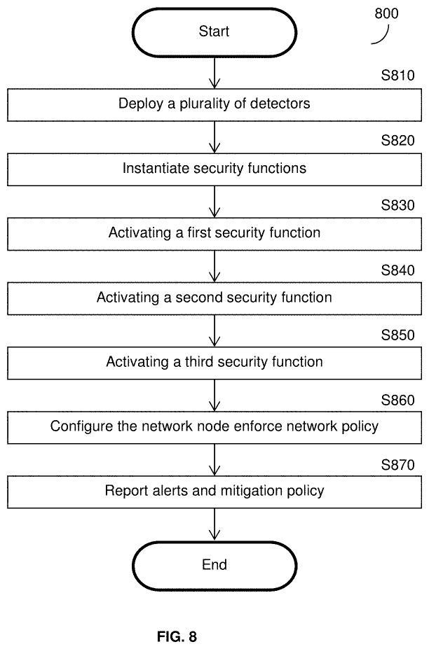

FIG. 8 is an example flowchart of a method for disaggregated detection denial-of-service (DDoS) attacks according to an embodiment. At S810, a plurality of detectors are deployed on a plurality of network nodes. As noted above, each network node may be connected to an edge network. At S820, a plurality of security functions on each of the plurality of detectors are instantiated.

At S830, a first security function for detecting anomalies in the telemetries received by the respective network node is activated. The telemetries are static on layers 3-4 traffic attributes. The detected anomalies are indicative of a potential DDoS attack.

At S840, a second security function for generating attack signatures based on the detected anomalies is activated. The second security function may be activated only upon anomaly detection.

At S850, a third security function is activated to generate at least one mitigation policy based on the generated attack signatures. The third security function may be activated only upon generation of attack signatures.

At S860, the respective network node is configured to enforce the at least one generated mitigation policy. The configured network node is the network node executing a detector that alerts on a potential DDoS attack.

At S870, any detected attack and mitigation polices are reported in a real-time to a controller (e.g., controller 250).

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A system for disaggregated detection denial-of-service (DDoS) attacks, comprising:
a plurality of detectors deployed on a plurality of network nodes, wherein each network node is connected to an edge network, wherein one detector of the plurality of detectors is deployed in each of the plurality of network nodes, wherein each of the plurality of detectors is configured to detect and characterize at least a DDoS attack by analyzing telemetries received by the respective network node in which the detector is deployed.

2. The system of claim 1, further comprising:
a controller communicatively connected to the plurality of detectors, wherein the controller is configured to at least provision the plurality of detectors.

3. The system of claim 1, wherein each of the plurality of detectors is further configured to:
generate a mitigation policy; and
set the respective network node in which the detector is deployed with the mitigation policy.

4. The system of claim 1, wherein each of the plurality of detectors is further configured to perform a first security function to detect anomalies in the telemetries received by the respective network node, wherein the detected anomalies are indicative of a potential DDoS attack.

5. The system of claim 4, wherein each of the plurality of detectors is further configured to perform a second security function to generate attack signatures based on the detected anomalies.

6. The system of claim 5, wherein each of the plurality of detectors is further configured to perform a third security function to generate at least one mitigation policy based on the generated attack signatures.

7. The system of claim 6, wherein the first security function, the second security function, and the third security function are instantiated on-demand, wherein each of the plurality of detectors is configured to execute a plurality of instances of each of the first security function, the second security function, and the third security function.

9. The system of claim 2, wherein the controller is further configured to generate a forensic report based on attacks detected by the plurality of detectors.

10. The system of claim 2, wherein the controller is further configured to: instantiate a new detector on one of the plurality of network nodes.

11. The system of claim 2, wherein the controller is further configured to:
cause setting of a first detector with a mitigation policy determined by a second detector.

12. The system of claim 1, wherein each detector of the plurality of detectors is deployed is activated, upon receiving a layer-1 anomaly.

13. The system of claim 1, wherein each of the plurality of detectors is realized a software agent executed over a hardware layer of the respective network node.

14. A method for disaggregated detection denial-of-service (DDoS) attacks, comprising:
deploying a plurality of detectors on a plurality of network nodes, wherein each network node is connected to an edge network; and
instantiating a plurality of security functions on each of the plurality of detectors, wherein the plurality of security functions;
activating a first security function to detect anomalies in the telemetries received by the respective network node, wherein the detected anomalies are indicative of a potential DDoS attack;
activating a second security function to generate attack signatures based on the detected anomalies; and
activating a third security function to generate at least one mitigation policy based on the generated attack signatures.

15. The method of claim 14, further comprising:
setting the respective network node with the at least one generated mitigation policy.

16. The method of claim 14, further comprising:
reporting, in real-time, all detected DDoS attacks to a controller.

17. The method of claim 14, further comprising:
receiving at least a first detector of the plurality of detectors a mitigation policy generated by a second detector.

18. The method of claim 14, wherein the telemetries are layer 3-4 telemetries.

19. The method of claim 14, wherein each of the plurality of detectors is realized a software agent executed over a hardware layer of the respective network node.

20. The method of claim 14, wherein the software agent is realized as any one of: a microservice, a software container, a lightweight virtual machine, wherein the software agent is realized as any one of: a microservice, a software container, a lightweight virtual machine.

21. The method of claim 14, wherein each detector of the plurality of detectors is deployed is activated, upon receiving a layer-1 anomaly.

22. A non-transitory computer readable medium having stored thereon instructions for causing a processing circuitry to execute a process, the process comprising:
deploying a plurality of detectors on a plurality of network nodes, wherein each network node is connected to an edge network; and
instantiating a plurality of security functions on each of the plurality of detectors, wherein the plurality of security functions;
activating a first security function to detect anomalies in the telemetries received by the respective network node, wherein the detected anomalies are indicative of a potential DDoS attack;
activating a second security function to generate attack signatures based on the detected anomalies; and
activating a third security function to generate at least one mitigation policy based on the generated attack signatures.
